(19) United States
(12) Patent Application Publication
(10) Pub. No.: US 2019/0151906 A1
(43) Pub. Date: May 23, 2019

(54) FUEL CLEANING SYSTEM

(71) Applicant: Leighton O'Brien Field Services Pty Ltd, Victoria (AU)

(72) Inventor: Robert James Moore, Victoria (AU)

(73) Assignee: Leighton O'Brien Field Services Pty Ltd, Victoria (AU)

(21) Appl. No.: 16/302,046

(22) PCT Filed: May 17, 2017
(86) PCT No.: PCT/AU2017/000112

§ 371 Date: Nov. 15, 2018

(30) Foreign Application Priority Data
May 17, 2016 (AU) 2016901843

(51) Int. Cl. B08B 9/093; B60S 5/00

(52) U.S. Cl. CPC B08B 9/093; B60S 5/00

(57) ABSTRACT

Systems for cleaning a storage tank and fluid hydrocarbons stored within the storage tank comprise: a vehicle for transporting the system between sites having said storage tanks; a fluid cleaning circuit mounted with respect to said vehicle for extracting fluid hydrocarbons from the storage tank for cleaning; a settlement tank mounted with respect to said vehicle to be in fluid communication with the fluid cleaning circuit to receive contaminated fluid hydrocarbons for separation by gravity; wherein the fluid cleaning circuit is controllable to clean the fluid hydrocarbons and the storage tank and to dispose of any waste material extracted from the fluid hydrocarbons during the cleaning process and following disposal of the waste material the fluid cleaning circuit is configured to convert the settlement tank into a non-volatile environment prior to the vehicle leaving the site.

### RELATED APPLICATIONS

The present application claims priority from Australian Provisional Patent Application No. 2016901843 filed 17 May 2017, the entire contents of which are incorporated herein by reference.

### FIELD OF INVENTION

The present invention relates generally to a system for cleaning fuel in an underground storage tank, and in particular, to a mobile system that can access a fuel storage site to clean fuel stored in the storage tanks located therein and can then leave the fuel storage site without being classified as a hazardous vehicle.

### BACKGROUND OF THE INVENTION

Storage tanks for storage fuel and other hydrocarbon products are well known. Many storage tanks are located close to an outlet for dispensing the fuel and for this reason, it may be necessary to store the tanks in safe locations, such as under the ground, as is the case with most fuel outlet or service stations.

Irrespective of whether the storage tank is located above the ground or under the ground, over time, the tank interior and the fuel present therein may deteriorate. This can result in tank rust, fuel polymerisation, condensation as well as the growth of organisms within the fuel. In instances where the integrity of the storage tank has become compromised, dirt and water can seep into the tank over time, significantly affecting the quality of the fuel contained therein and generating a layer of sediment and other solid material within the tank. Similarly, in some instances the storage tank may become contaminated even though the integrity of the tank has not been compromised. This may occur during fuel delivery in the presence of spill box overflows, where contaminated fuel may enter the storage tank.

In many instances, the poor quality of the fuel present in the storage tank may not become noticed until equipment or vehicles using the fuel begin to fail or report operational problems. In recent times a variety of monitoring systems have been proposed to monitor the quality of fuel being stored in such storage tanks. Whilst such systems have proven effective in the early identification of problems with fuel quality, there is still a need to undertake a process of cleaning the fuel present in the tank.

The present Applicant has developed a fuel and fuel tank treatment system for cleaning fuel present in an underground tank that has become contaminated. This system is described in the Applicant's U.S. Pat. No. 8,753,451, the entire contents of which are incorporated herein by reference. This system has proven effective in cleaning fuel as well and by extension, the tank containing the fuel, whilst also minimising fuel wastage. This is done through the incorporation of a settlement tank that receives the most contaminated fuel present in the storage tank for separation, as well as a cleaning circuit that can circulate and clean the remaining fuel in the tank as the most contaminated fuel is being treated. In a preferred embodiment, the cleaning circuit and the settlement tank is provided within a vehicle structure such that the vehicle can travel to a site to perform the cleaning function, as required.

However, one problem with providing a vehicle that can travel to remote sites and which contains a settlement tank for storing fuel for cleaning is that the settlement tank must be completely purged of fuel and fuel products prior to the vehicle leaving the site. If this does not occur and waste fuel or other such fuel product is retained in the tanks of the vehicle, the vehicle becomes classified as being a carrier of dangerous or hazardous materials and is restricted in relation to its activities.

Thus, there is a need to provide a fuel cleaning system that is mobile and which can travel between sites to clean fuel and fuel tanks and which ensures that at the end of the cleaning process, the vehicle is purged from carrying any fuel or fuel related by products within the tanks of the system, and is safe to access the roads.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a mobile system for cleaning a storage tank and fluid hydrocarbons stored within the storage tank comprising:
a vehicle for transporting the system between sites having said storage tanks;
a fluid cleaning circuit mounted with respect to said vehicle for extracting fluid hydrocarbons from the storage tank for cleaning;
a settlement tank mounted with respect to the vehicle to be in fluid communication with the fluid cleaning circuit to receive contaminated fluid hydrocarbons for separation by gravity;
wherein the fluid cleaning circuit is controllable to clean the fluid hydrocarbons and the storage tank and to dispose of any waste material extracted from the fluid hydrocarbons during the cleaning process and following disposal of the waste material the fluid cleaning circuit is configured to convert the settlement tank into a non-volatile environment prior to the vehicle leaving the site.

In one embodiment, the fluid cleaning circuit may comprise an inert gas source that is selectively connected to the settlement tank after the waste material has been disposed therefrom to purge the settlement tank. The inert gas source may be a compressed Nitrogen source contained within the vehicle.

Prior to connection of the settlement tank to the inert gas source, an interior of the settlement tank may be washed with a washdown liquid. The washdown liquid may be applied to the interior of the settlement tank by way of spray nozzles which deliver the washdown liquid under pressure.

Accordingly, in another aspect of the invention there is provided a method of processing a hydrocarbon liquid stored in a storage tank, the hydrocarbon liquid comprising contaminants in the form of suspended particles and/or emulsified liquids, the method comprising: extracting the most contaminated portion of the hydrocarbon liquid from the storage tank and delivering the most contaminated portion into a settlement tank to separate the most contaminated portion of hydrocarbon liquid into a contaminated portion substantially containing the suspended particles and/or the emulsified liquids and a fuel portion substantially containing the hydrocarbon liquid; cleaning the hydrocarbon liquid present in the storage tank and the hydrocarbon liquid obtained from the settlement tank to further remove any of the suspended particles and/or the emulsified liquids therefrom to form a cleaned fuel; returning the cleaned fuel to the storage tank; disposing of any suspended particles and/or emulsified liquids obtained from the hydrocarbon liquid; cleaning the settlement tank to substantially remove any remnant hydrocarbon liquid, suspended particles and/or emulsified liquids present therein; and purging the settlement tank to create an inert atmosphere within the settlement tank.

In an embodiment of this aspect of the invention, the step of extracting the most contaminated portion of the hydrocarbon liquid from the storage tank comprises extracting the lowermost portion of hydrocarbon liquid from the storage tank. Separation of the most contaminated portion of hydrocarbon liquid into a contaminated portion substantially containing the suspended particles and/or the emulsified liquids and a fuel portion substantially containing the hydrocarbon liquid may occur under gravity in the settlement tank.

The step of cleaning the hydrocarbon liquid present in the storage tank and the hydrocarbon liquid obtained from the settlement tank may comprise passing the hydrocarbon liquid through at least one cycle of a fuel cleaning circuit. The fuel cleaning circuit may comprise one or more of a water/particulate separator, magnetic strainer, detergent dispenser and a filter.

The cleaned fuel may be formed when the purity of the hydrocarbon liquid is deemed to achieve a predetermined purity level. The step of deeming whether the purity of hydrocarbon liquid has achieved a predetermined purity level may comprise testing the purity of the hydrocarbon liquid as it passes through the fuel cleaning circuit.

In one embodiment, the step of returning the cleaned fuel to the storage tank may comprise returning the cleaned fuel to the storage tank from which it was extracted. In another embodiment, the step of returning the cleaned fuel to the storage tank may comprise returning the cleaned fuel to a different storage tank from which it was extracted.

The step of disposing of any suspended particles and/or emulsified liquids may comprise disposing the suspended particles and/or emulsified liquids into a dedicated disposal receptacle.

The step of cleaning the settlement tank may comprise washing the interior of the settlement tank with a liquid. The liquid may be applied to the interior of the settlement tank by way of spray nozzles which deliver the liquid to the interior walls of the settlement tank under pressure.

The step of purging the settlement tank may comprise connecting an inert gas source to the settlement tank to purge the settlement tank. The inert gas source may be a compressed Nitrogen source.

### BRIEF DESCRIPTION OF THE DRAWINGS

The invention may be better understood from the following non-limiting description of preferred embodiments, in which:

FIG. 1 is a diagram of a vehicle containing a fuel cleaning system in accordance with an embodiment of the present invention;

FIG. 2 is a circuit diagram depicting a manner in which the system of FIG. 1 is able to deliver contaminated fuel from a storage tanks for settlement;

FIG. 3 is a circuit diagram depicting a manner in which the system of FIG. 1 is able to clean fuel present in a storage tank in a cyclical manner;

FIG. 4 is a circuit diagram depicting a manner in which the system of FIG. 1 is able to apply cleaning to the separated fuel portion present after settlement in the settlement tank after a period of settlement;

FIG. 5 is a circuit diagram depicting a manner in which the system of FIG. 1 is able to remove waste materials separated from the fuel in the settlement tank after a period of settlement;

FIG. 6 is a circuit diagram depicting a manner in which the system of FIG. 1 is able to clean the settlement tank of fuel and residual waste materials following settlement;

FIG. 7 is a circuit diagram depicting a manner in which the system of FIG. 1 is able to process the settlement tank to provide a non-volatile environment after use;

FIG. 8 is a circuit diagram depicting the various components of the fuel cleaning system of FIG. 1; and

FIG. 9 is a flow chart depicting a method of processing a hydrocarbon liquid stored in a storage tank in accordance with an embodiment of the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application for cleaning a fuel, such as a diesel fuel, in an underground storage tank arrangement. However, it will be appreciated that the present invention could be employed in a variety of applications for cleaning a variety of liquid hydrocarbons stored in a variety of storage vessels and still fall within the scope of the present invention.

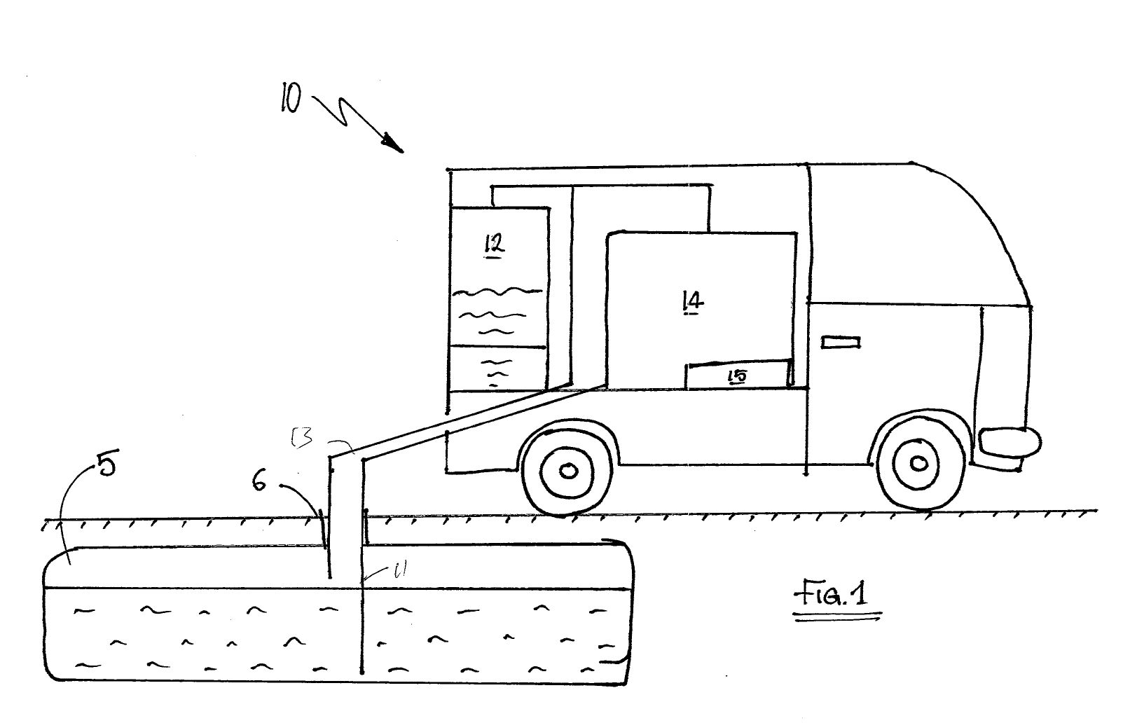

Referring to FIG. 1, a cleaning vehicle 10 in accordance with an embodiment of the present invention is depicted. The vehicle 10 is a mobile fuel and fuel tank cleaning system and comprises a settlement tank 12 for the temporary storage of contaminated fuel during the cleaning process, and a fuel cleaning circuit 14 through which the contaminated fuel is passed for cleaning. Both the settlement tank 12 and the fuel cleaning circuit 14 are housed within the vehicle 10 and are controlled by a control system 15 which may include pneumatic, electronic or other controller means.

Upon receiving a request to clean a subterranean fuel storage tank 5, the vehicle 10 attends the site and is positioned adjacent a hatch 6 of the storage tank 5. The hatch 6 is located in the ground surface and provides access to the interior of the storage tank 5, requiring treatment. A lift tube 11 is then inserted into the storage tank 5 such that its distal end is located adjacent the floor of the storage tank 5, namely where the most contaminated fuel and any inclusions or microbes are likely to dwell. The lift tube 11 is in fluid communication with the fuel cleaning circuit 14 which is also in fluid communication with the settlement tank 12 and a return tube 13 which is also inserted through the hatch 6 into the upper region of the storage tank 5.

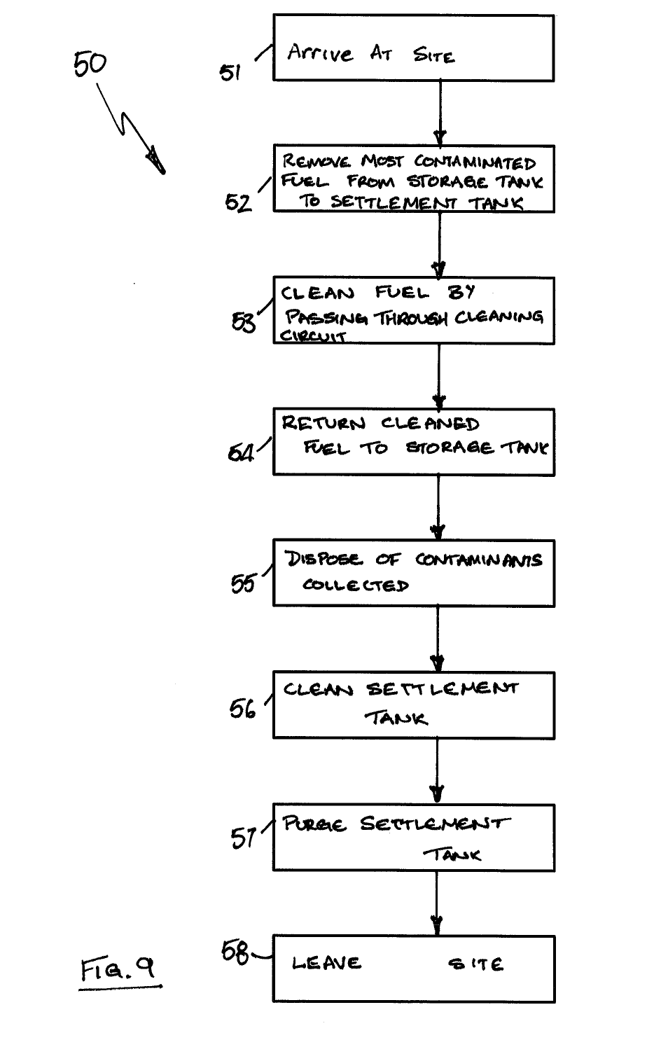

Once the vehicle 10 has been set up in this position as shown in FIG. 1, the fuel cleaning circuit 14 can be operated to clean the fuel contained in the fuel storage tank 5. The composition of the fuel cleaning circuit 14 is depicted in FIG. 8.

As depicted, the fuel cleaning circuit 14 comprises three main portions: the cleaning and waste disposal portion 17; the settlement portion 18; and the circuit purging portion 19. The cleaning and waste disposal portion 17 is that part of the fuel cleaning circuit 14 that handles and cleans the fuel. The settlement portion 18 is that part of the fuel cleaning circuit 14 that receives the most contaminated portion of fuel present in the storage tank 5 and uses gravity settling techniques to separate the impurities from the fuel. The circuit purging portion 19 is the part of the fuel cleaning circuit that purges the entire system of the vehicle 10 of fuel and fuel related residue, so that the vehicle can leave the site without containing any hazardous materials and without requiring the restrictions of use generally associated with being classified as a hazardous vehicle.

The cleaning and waste disposal portion 18 of the fuel cleaning circuit 14 generally comprises a valve 21 that is controllable to open the lift tube 11 to draw fuel from the storage tank 5 and into the magnetic strainer 20 which removes any metallic contaminants present in the fuel. A valve 22 is provided to isolate the magnetic strainer 20 from the diaphragm pump 24, as required. The diaphragm pump 24 will be selected to have a transfer rate sufficient to draw the fuel from the storage tank 5 and around the fuel cleaning circuit 14. A water/particulate separator 26 is provided to remove any water and particulate present in the fuel. Such devices are well known in the art and generally create a vortex in the fluid as it passes therethrough which aids in separating the water and particulate matter from the fluid for collection and disposal. A detergent dispenser 27 is provided to add a measured amount of detergent to the fuel prior to recirculation of the fuel back into the storage tank 5. The presence of the detergent in the recirculated fuel acts to loosen any deposits of rust or biological material from the surfaces of the storage tank 5 as the recirculation occurs. Any such deposits will be taken up in the fuel as it circulates through the cleaning and waste disposal portion 18 of the fuel cleaning circuit 14 for removal therefrom. An additional and less course filter 28 is then provided to further process the fuel after which the fuel passes through a flow meter 30 before being delivered back into the storage tank 5 via the return tube 13, or to an alternative storage means. The flow meter 30 enables the fuel to be sampled as it is recirculated through the circuit 14, such that it can be cycled through the cleaning circuit 14 until it reaches a predetermined level of purity, as set by the control system 15. The control system 15 may be a computer operated system that coordinates the various components of the cleaning circuit 14 according to sensed conditions. The control system 15 may be fully automated or may be controlled by a human controller operating the computer system.

In the embodiment as depicted, the settlement tank 12 that is located in the vehicle 10 is shaped with a sloping bottom surface such that any fuel and contaminant present therein is directed towards a drain located at the lowest point of the floor. This functions to minimise the likelihood of fuel and/or contaminant remaining in the tank 12 at the end of the cleaning process. The settlement tank 12 is preferably made from a stainless steel material, although other materials, such as plastics and other inert metals are also envisaged.

Spray nozzles 31 are mounted within the settlement tank 12 and are in fluid communication with a cleaning liquid storage tank 35 to facilitate spray cleaning of the settlement tank after use. Cleaning liquid, in the form of a detergent or the like, is delivered under pressure created by the diaphragm pump 34 to clean the surfaces of the settlement tank 12 to remove any fuel residue or waste from the settlement tank 12 after use.

A compressed inert gas source 36, typically compressed nitrogen, is in fluid communication with the settlement tank 12 to perform a nitrogen purge of the settlement tank 12, after cleaning, as will be described in more detail below. A vent 32 is formed in the settlement tank 12 to facilitate such purging.

The manner in which the system of the present invention is controlled to clean a fuel storage tank in accordance with an embodiment of the present invention will be described below.

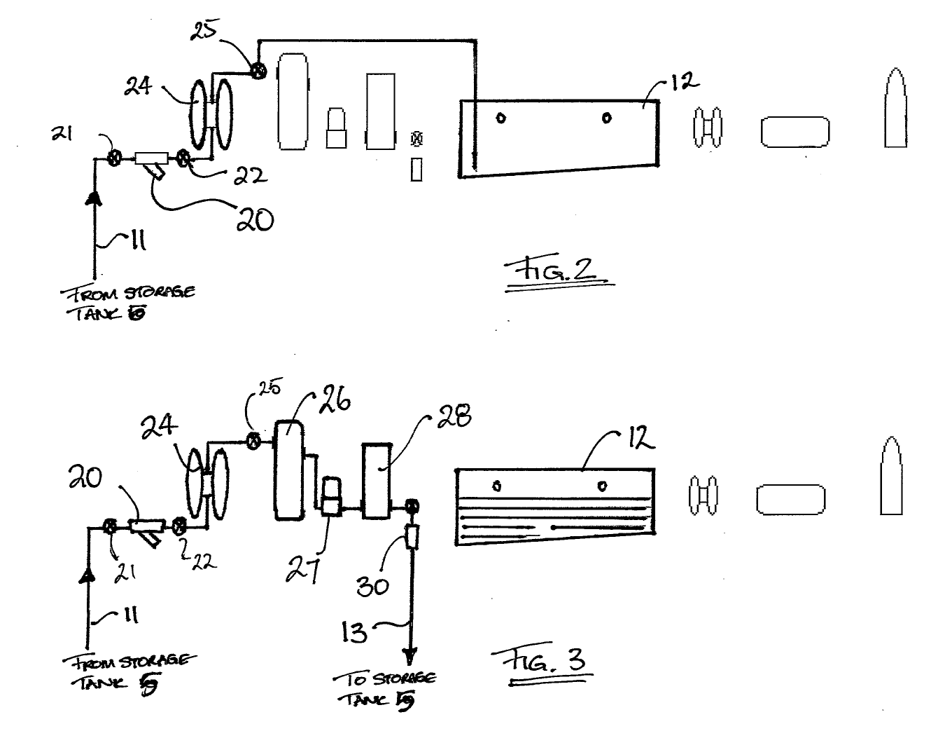

As is shown in FIG. 2, to initiate fuel cleaning, the most contaminated fuel present at the bottom of the storage tank 5 is initially drawn from the tank 5 by activating diaphragm pump 24 and opening ball valves 21 and 22. This causes the fuel being extracted from the storage tank 5 to pass through the magnetic strainer 20 to remove any metallic contaminants and larger sized particulate matter from the fuel. Valve 25 is then opened to cause the fuel and sludge/contaminants to be directly delivered into the settlement tank 12 where it will be allowed to settle under gravity into an upper layer of lighter fuel and a lower layer(s) of heavier contaminants, including particulate matter and water.

As is shown in FIG. 3, after the lowermost layers of fuel present in the storage tank 5 have been delivered into the settlement tank 12, the remaining fuel present in the storage tank 5 is then able to undergo one or more cleaning cycles. To perform this, the diaphragm pump 24 draws the fuel from the storage tank 5 through the magnetic strainer 20. The valve 25 is then activated to redirect the fuel to flow through the water particle separator 26, detergent dispenser 27 and filter 28 where the fuel is cleaned and processed to remove contaminants in the form of water and particulate matter therefrom. Samples of the fuel are able to be taken from the treated fuel as it passes through the flow meter 30 to determine whether the fuel is at or above a predetermined level of purity. If the fuel is below such a level, as dictated by the control system 15, the fuel is delivered back into the storage tank 5 and recycled through the cleaning and waste disposal portion 17 of the circuit 14 until the desired level of fuel purity is achieved. Due to the presence of the detergent in the fuel, during each cycle the fuel redeposited into the tank is able to loosen deposits of rust and biological matter from the walls of the storage tank 5 for removal by the cleaning circuit 14, thereby cleaning the tank in the process. If, at the time of achieving the desired level of purity of the fuel the tank is deemed to be lacking the appropriate integrity to retain the cleaned fuel in a contained state, the cleaned fuel may be delivered to an alternative storage, as dictated by the site operator following an assessment of the integrity of the storage tank 5.

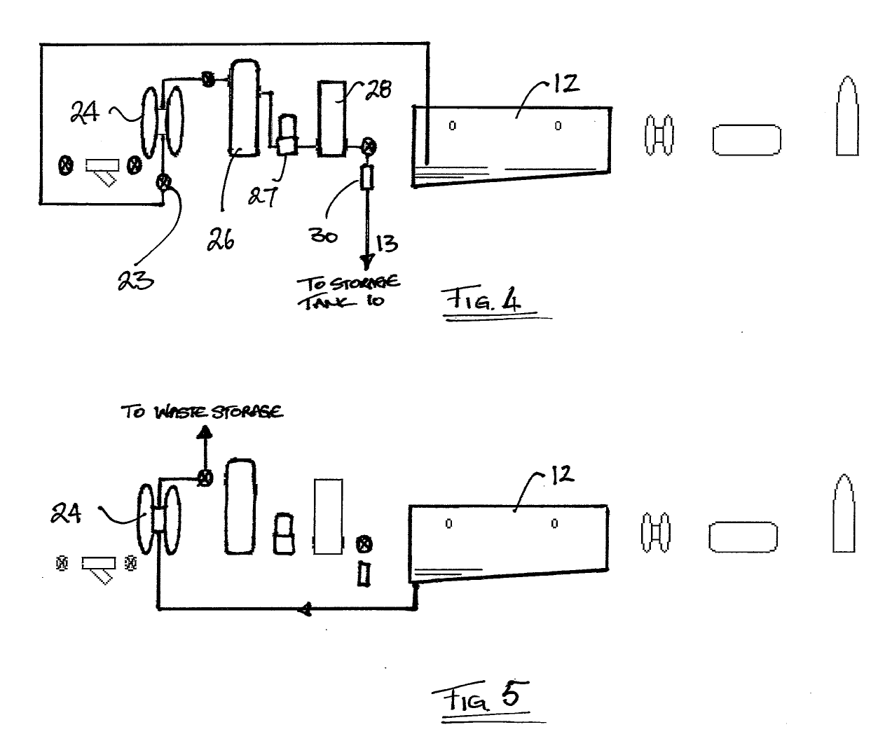

Referring to FIG. 4, during the time taken to clean the fuel present in the storage tank 5 as described above in relation to FIG. 3, the contaminated fuel present in the settlement tank 12 of the vehicle 10 will likely have had sufficient time to separate under gravity to form a lower layer of sludge or sediment, water and fuel floating above the lower layer. This fuel is then able to be drawn by diaphragm pump 24 so as to be passed through the water/particle separator 26, detergent dispenser 27, and filter 28 to be further cleaned before being returned to the fuel storage tank 5 or to an alternative storage means. It will be appreciated that the fuel taken from the settlement tank 12 may also include a portion of the contaminant present therein, which is then removed from the fuel as it passes through the elements of the cleaning portion. Such an action ensures that fuel wastage is minimised whilst maintaining a degree of purity of the fuel. In this regard, rather than waiting until the fuel in the storage tank 5 has been cleaned before processing the fuel layer from the settlement tank, the fuel layer from the settlement tank 12 may be cleaned with the fuel in the storage tank 5, thereby further reducing the overall time taken to perform the cleaning function. As a result, the settlement tank 12 will then comprise sludge and sediment layer and some water, with only a very minimal amount of residual fuel present therein.

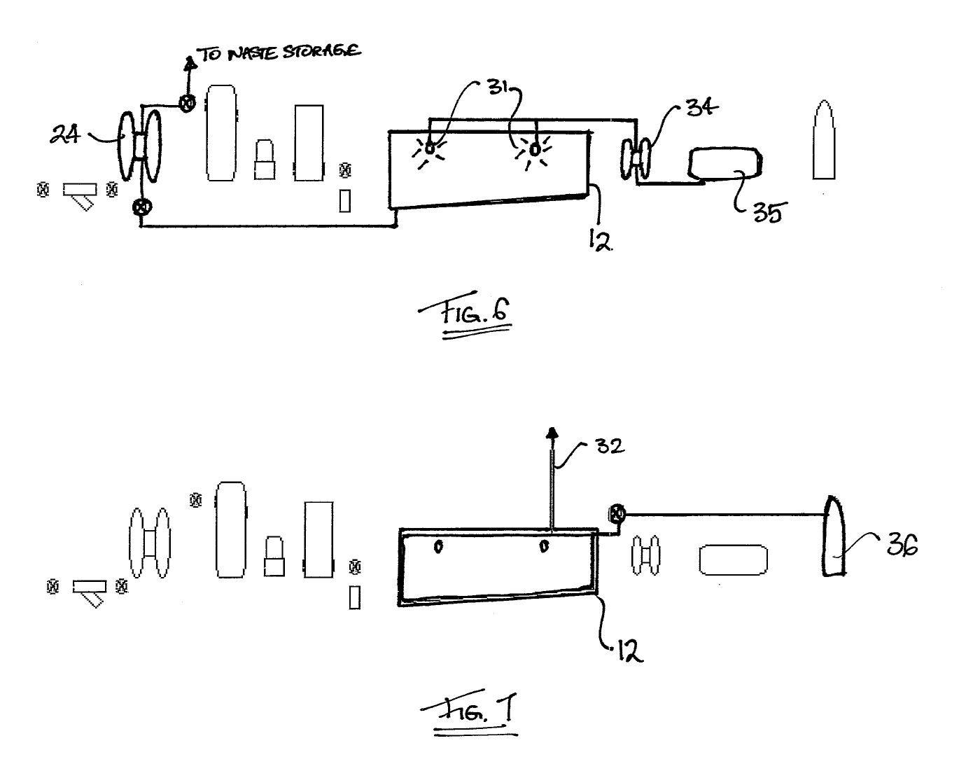

As is shown in FIG. 5, the water, sludge, sediment and residual fuel present in the settlement tank 12 is drawn therefrom via diaphragm pump 24 through the outlet formed at the lower most point of the floor of the settlement tank 12. The contaminants comprising the sludge, sediment, water and residual fuel is then delivered to a waste storage for disposal.

The present invention is directed towards a system that not only cleans fuel and disposes of the waste material, but also a system that ensures that the vehicle 10 is treated in such a manner that no residual fuel or fuel products are inadvertently retained by the system. This enables the vehicle to maintain its status as a service vehicle, rather than a vehicle that is equipped to carry hazardous chemicals, as may be the case where the settlement tank retains fuel and/or fuel residue.

For this reason, following removal of the sludge and sediment from the settlement tank as described in FIG. 5 above, the settlement tank 12 is cleaned in the manner as depicted in FIG. 6. In this regard, the diaphragm pump 34 is activated to deliver washdown liquid from the washdown liquid storage tank 35 to the nozzles 31 under pressure. The washdown liquid is then sprayed from the nozzles 31 so as to cover the internal surfaces of the settlement tank 12. The diaphragm pump 24 is then activated to draw the washdown liquid from the outlet in the settlement tank to be delivered to a waste storage for disposal. As the washdown liquid collects in the settlement tank, it captures any leftover sludge and fuel residue, thereby ensuring that the settlement tank is cleared of any volatile material.

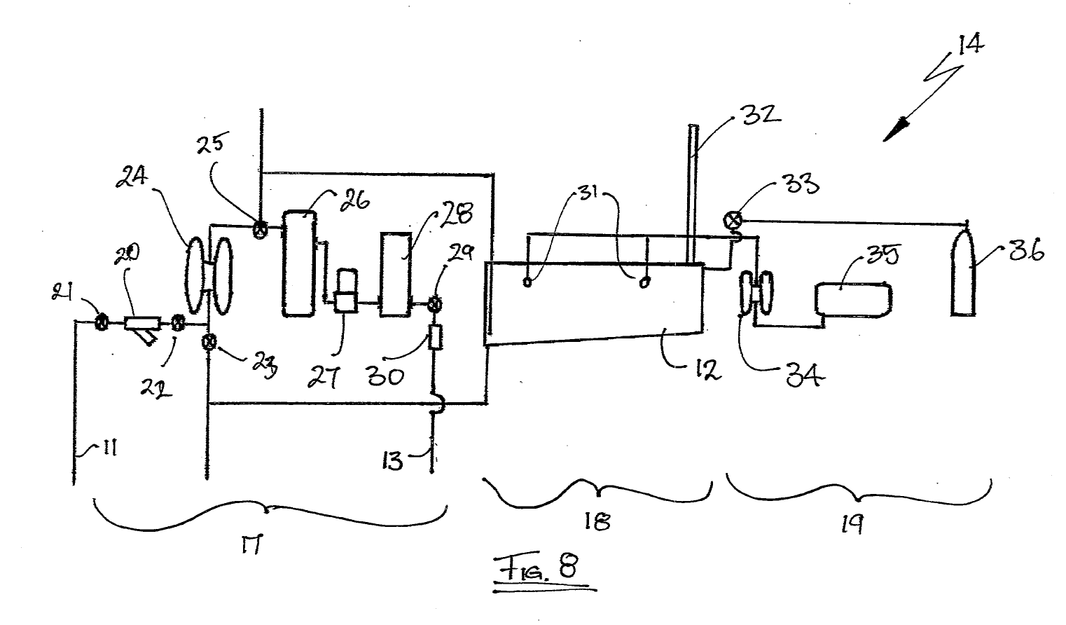

To further ensure that the settlement tank is restored to a safe and non-volatile environment, the arrangement as depicted in FIG. 7 is initiated. The control system 15 functions to close off the outlet of the settlement tank 12 and connects the settlement tank 12 to the compressed inert gas source 36. This causes the inert gas to enter the settlement tank to purge any oxygen from the settlement tank 12 via the vent 32. This then results in a Nitrogen rich non-reactive environment that ensures that the vehicle 10 is able to leave the site without requiring hazardous material classification.

As is shown in FIG. 9, the control system of the present invention can be operated in accordance with method 50, to provide a simple and effective means for performing the cleaning function. At step 51, the vehicle arrives at the site containing the storage tank to be cleaned. In step 52, the control system functions to remove the most contaminated fuel present in the lower region of the storage tank and deliver that contaminated fuel to a settlement tank for separate treatment. In step 53, the control system then cleans the fuel present in the storage tank as well as any fuel obtained from the settlement tank to achieve a degree of fuel purity. In step 54 this cleaned fuel is returned to the storage tank, or an alternative storage tank for use. In step 55 any particulate matter, water or any other impurity obtained from the fuel is collected and disposed of from the various components of the system. In step 56 the settlement tank is then cleaned and in step 57 the settlement tank is purged of oxygen to generate an inert atmosphere within the settlement tank. In step 58 the vehicle can leave the site in a safe an effective manner, without restrictions of being a hazardous vehicle transporting fuel or other combustibles.

It will be appreciated that the fuel cleaning system and method of operation of the present invention provides a mobile means for cleaning fuel storage tanks, especially those fuel storage tanks that have been assessed as contaminated in a safe and efficient manner. The system is contained within a service vehicle that maintains a non-volatile environment for handling the fuel being cleaned. Such a system enables vehicles to function without the need to be classified as a hazardous chemical vehicle, greatly simplifying the fuel cleaning system whilst maintaining a safe and efficient work environment.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

What is claimed is:

1-20. (canceled)

21. A system for cleaning a storage tank and fluid hydrocarbons stored within the storage tank comprising:
a vehicle for transporting the system between sites having said storage tanks;
a fluid cleaning circuit mounted with respect to said vehicle for extracting fluid hydrocarbons from the storage tank for cleaning; and
a settlement tank mounted with respect to said vehicle to be in fluid communication with the fluid cleaning circuit to receive contaminated fluid hydrocarbons for separation by gravity,
wherein the fluid cleaning circuit is controllable to clean the fluid hydrocarbons and the storage tank and to dispose of any waste material extracted from the fluid hydrocarbons during a cleaning process and following disposal of the waste material the fluid cleaning circuit is configured to convert the settlement tank into a non-volatile environment prior to the vehicle leaving a site associated with the storage tank.

22. The system of claim 21, wherein the fluid cleaning circuit comprises an inert gas source that is selectively connected to the settlement tank after the waste material has been disposed therefrom to purge the settlement tank.

23. The system of claim 22, wherein the inert gas source is a compressed Nitrogen source contained within the vehicle.

24. The system of claim 22 wherein prior to connection of the settlement tank to the inert gas source, an interior of the settlement tank is washed with a liquid.

25. The system of claim 24, wherein the liquid is applied to the interior of the settlement tank by way of spray nozzles which deliver the liquid to interior walls of the settlement tank under pressure.

26. A method of processing a hydrocarbon liquid stored in a storage tank; the hydrocarbon liquid comprising contaminants in a form of suspended particles and/or emulsified liquids, the method comprising:
extracting the most contaminated portion of the hydrocarbon liquid from the storage tank and delivering the most contaminated portion into a settlement tank to separate the most contaminated portion of hydrocarbon liquid into a contaminated portion substantially containing the suspended particles and/or the emulsified liquids and a fuel portion substantially containing the hydrocarbon liquid;
cleaning the hydrocarbon liquid present in the storage tank and the hydrocarbon liquid obtained from the settlement tank to further remove any of the suspended particles and/or the emulsified liquids therefrom to form a cleaned fuel;
returning the cleaned fuel to the storage tank;
disposing of any suspended particles and/or emulsified liquids obtained from the hydrocarbon liquid;
cleaning the settlement tank to substantially remove any remnant hydrocarbon liquid, suspended particles and/or emulsified liquids present therein; and
purging the settlement tank to create an inert atmosphere within the settlement tank.

27. The method of claim 26, wherein the step of extracting the most contaminated portion of the hydrocarbon liquid from the storage tank comprises extracting the lowermost portion of hydrocarbon liquid from the storage tank.

28. The method of claim 26, wherein separation of the most contaminated portion of hydrocarbon liquid into a contaminated portion substantially containing the suspended particles and/or the emulsified liquids and a fuel portion substantially containing the hydrocarbon liquid occurs under gravity in the settlement tank.

29. The method of claim 26 wherein the step of cleaning the hydrocarbon liquid present in the storage tank and the hydrocarbon liquid obtained from the settlement tank comprise passing the hydrocarbon liquid through at least one cycle of a fuel cleaning circuit.

30. The method of claim 29, wherein the fuel cleaning circuit comprises one or more of a water/particulate separator, magnetic strainer, detergent dispenser and a filter.

31. The method of claim 29, wherein the cleaned fuel is formed when a purity of the hydrocarbon liquid is determined to have achieved a predetermined purity level.

32. The method of claim 31, wherein the step of determining whether the purity of the hydrocarbon liquid has achieved a predetermined purity level comprises testing the purity of the hydrocarbon liquid as it passes through the fuel cleaning circuit.

33. The method of claim 26, wherein the step of returning the cleaned fuel to the storage tank comprises returning the cleaned fuel to the storage tank from which it was extracted.

34. The method of claim 26, wherein the step of returning the cleaned fuel to the storage tank comprises returning the cleaned fuel to a different storage tank from which it was extracted.

35. The method of claim 26, wherein the step of disposing of any suspended particles and/or emulsified liquids comprises disposing the suspended particles and/or emulsified liquids into a dedicated disposal receptacle.

36. The method of claim 26, wherein the step of cleaning the settlement tank comprises washing an interior of the settlement tank with a liquid.

37. The method of claim 36, wherein the liquid is applied to the interior of the settlement tank by way of spray nozzles which deliver the liquid to interior walls of the settlement tank under pressure.

38. The method of claim 26, wherein the step of purging the settlement tank comprises connecting an inert gas source to the settlement tank to purge the settlement tank.

39. The method of claim 38, wherein the inert gas source is a compressed Nitrogen source.

40. The method of claim 39, wherein at least the extracting of the most contaminated portion of the hydrocarbon liquid from the storage tank and delivering the most contaminated portion into a settlement tank, the cleaning the hydrocarbon liquid, and the returning the cleaned fuel, are undertaken in a vehicle.
